(19) United States
(12) Patent Application Publication
(10) Pub. No.: US 2016/0167975 A1
(43) Pub. Date: Jun. 16, 2016

(54) HYDROGEN CYANIDE MANUFACTURING PROCESS WITH SECOND WASTE HEAT BOILER

(71) Applicant: INVISTA TECHNOLOGIES S.A R.L., St. Gallen (CH)

(72) Inventors: John C. CATON, Yoakum, TX (US); John J. OSTERMAIER, Orange, TX (US); William J. STEINER, Bridge City, TX (US)

(73) Assignee: INVISTA NORTH AMERICA S.A R.L., WILMINGTON (DE)

(21) Appl. No.: 14/903,658

(22) PCT Filed: Jul. 10, 2014
(86) PCT No.: PCT/US2014/046130

§ 371 Date: Jan. 8, 2016

Related U.S. Application Data
(60) Provisional application No. 61/845,617, filed on Jul. 12, 2013.

(51) Int. Cl. C01C 3/02

(52) U.S. Cl. CPC C01C 3/0295

(57) ABSTRACT

Described is a method for the production and recovery of hydrogen cyanide, which includes removing ammonia from a crude hydrogen cyanide stream. The method integrates heat removed from a crude hydrogen cyanide stream into other areas of the hydrogen cyanide recovery process. The crude hydrogen cyanide stream may be passed through a first waste heat boiler and a second waste heat boiler prior to being fed to an ammonia absorber, which produces a hydrogen cyanide rich stream. Hydrogen cyanide is recovered from the hydrogen cyanide rich stream. Equipment fouling with HCN polymer is reduced.

### CROSS REFERENCE TO RELATED APPLICATION

This application claims priority to U.S. App. 61/845617, filed Jul. 12, 2013, the entire contents and disclosures of which are incorporated herein.

### FIELD OF THE INVENTION

The present invention is directed to a process for manufacturing and recovering hydrogen cyanide. In particular, the present invention is directed to improving process efficiency and hydrogen cyanide recovery by using a second waste heat boiler.

### BACKGROUND OF THE INVENTION

Conventionally, hydrogen cyanide (“HCN”) is produced on an industrial scale according to either the Andrussow process or the BMA process. (see e.g., Ullmann's Encyclopedia of Industrial Chemistry, Volume A8, Weinheim 1987, pages 161-163) For example, HCN can be commercially produced by reacting ammonia with a methane-containing gas and an oxygen-containing gas at elevated temperatures in a reactor in the presence of a suitable catalyst (U.S. Pat. No. 1,934,838). HCN exits the reactor at high temperatures and is rapidly quenched to prevent decomposition of hydrogen cyanide and unreacted ammonia. Prior to the recovery of HCN, the HCN is cooled using a heat exchanger, as described in U.S. Pat. Nos. 2,782,107 and 3,215,495, or using a cooling solution, as described in U.S. Pat. Nos. 2,531,287 and 2,706,675. Some processes employ both a heat exchanger and cooling solution. Once cooled, unreacted ammonia is separated from HCN by contacting the crude hydrogen cyanide stream with an aqueous solution of ammonium phosphate in an ammonia absorber. The separated ammonia is recovered, purified and concentrated for recycle to HCN synthesis. HCN is recovered from the treated reactor exit gas typically by absorption into water followed by refining steps necessary to produce purified HCN.

Heat exchangers are widely used in cooling HCN and generally consist of indirect heat exchangers with a tubesheet and a number of tubes. The tubesheet defines a vessel for holding a heat transfer medium, such as water, which may allow the steam generation. These heat exchangers also generate steam, and are referred to as waste heat boilers. When using heat exchangers, cooling below the dew point of HCN must be avoided to prevent polymerization. This limits the amount of cooling possible with heat exchangers and may lead to fouling when ammonia is separated. To improve the service-life of indirect tubesheets, there has been extensive development of ferrules to protect the tube inlet, as described in U.S. Pat. Nos. 3,703,186, 5,775,269, 6,173,682, 6,960,333, and 7,574,981.

Using a cooling solution can reduce the temperature of the HCN to less than 100° C. The cooling solution may contain water and optionally an acid. The acid acts to inhibit polymerization of the HCN, but makes ammonia recovery difficult depending on the acid used.

U.S. Pat. No. 8,133,458 is directed to a reactor for converting methane, ammonia, oxygen and alkaline or alkaline earth hydroxides into alkaline or alkaline earth cyanides, wherein the reactor product is quenched with water, cooled, and then sent to a scrubber or absorption tower to recover sodium cyandie.

Thus, the need exists for processes that improve cooling of HCN while also reducing polymerization of hydrogen cyanide and reducing equipment fouling.

The references mentioned above are hereby incorporated by reference.

### SUMMARY OF THE INVENTION

In one embodiment, the present invention is directed to a method for recovering hydrogen cyanide from a crude hydrogen cyanide stream, comprising: directly passing the crude hydrogen cyanide stream comprising hydrogen cyanide and ammonia through a first waste heat boiler to form a reduced temperature hydrogen cyanide stream; directly passing the reduced temperature hydrogen cyanide stream through a second waste heat boiler to form a cooled hydrogen cyanide stream; separating the cooled hydrogen cyanide stream in an ammonia absorber to form an ammonia rich stream and a hydrogen cyanide stream; and recovering hydrogen cyanide from the hydrogen cyanide stream. During the cooling of the crude hydrogen cyanide stream in the multiple waste heat boilers, no cooling water and no inhibitors are added. The crude hydrogen cyanide stream may be formed by an oxygen Andrussow process, an air Andrussow process, an enriched air Andrussow process, or a BMA process. The temperature of the crude hydrogen cyanide stream is at least 1000° C. The temperature of the reduced temperature hydrogen cyanide stream is at least 200° C. and the temperature of the cooled hydrogen cyanide stream is at least 130° C., e.g., 130° C. to 150° C. The first waste heat boiler recovers heat from the crude hydrogen cyanide stream and may produce high-pressure stream while the second waste heat boiler recovers heat from the reduced temperature hydrogen cyanide stream and may produce low-pressure steam. The cooled hydrogen cyanide stream is in the vapor phase and may comprise less than 5 wt. % liquid, e.g., less than 3 wt. % liquid. A lean ammonium phosphate stream may be fed to the ammonia absorber. Additionally, an acid stream, e.g., a dilute acid stream, may be fed to the ammonia absorber and may comprise phosphoric acid. The ammonia rich stream may comprise greater than 50 wt. % of the ammonia from the crude hydrogen cyanide stream.

In another embodiment, the present invention is directed to a method for reducing hydrogen cyanide polymerization, comprising: directly passing a crude hydrogen cyanide stream comprising hydrogen cyanide and ammonia through a first waste heat boiler to form a reduced temperature hydrogen cyanide stream; directly passing the reduced temperature hydrogen cyanide stream through a second waste heat boiler to form a cooled hydrogen cyanide stream; separating the cooled hydrogen cyanide stream in an ammonia absorber to form an ammonia rich stream and a hydrogen cyanide stream; and recovering hydrogen cyanide from the hydrogen cyanide stream; wherein the cooled hydrogen cyanide stream has a temperature of 120° C. to 200° C., e.g., 130° C. to 150° C. The crude hydrogen cyanide stream may be formed by an oxygen Andrussow process, an air Andrussow process, an enriched air Andrussow process, or a BMA process. The temperature of the crude hydrogen cyanide stream is at least 1000° C. The temperature of the reduced temperature hydrogen cyanide stream is at least 200° C. and the temperature of the cooled hydrogen cyanide stream is at least 130° C. The first waste heat boiler recovers heat from the crude hydrogen cyanide stream and may produce high-pressure steam while the second waste heat boiler recovers heat from the reduced temperature hydrogen cyanide stream and may produce low-pressure steam. The cooled hydrogen cyanide stream is in the vapor phase and may comprise less than 5 wt. % liquid, e.g., less than 3 wt. % liquid. A lean ammonium phosphate stream may be fed to the ammonia absorber. Additionally, an acid stream, e.g., a dilute acid stream, may be fed to the ammonia absorber and may comprise phosphoric acid. The ammonia rich stream may comprise greater than 50 wt. % of the ammonia from the crude hydrogen cyanide stream.

In yet another embodiment, the present invention is directed to a method for reducing hydrogen cyanide polymerization, comprising: passing a crude hydrogen cyanide stream comprising hydrogen cyanide and ammonia through a first waste heat boiler to form a reduced temperature hydrogen cyanide stream; passing the reduced temperature hydrogen cyanide stream through a second waste heat boiler to form a cooled hydrogen cyanide stream; separating the cooled hydrogen cyanide stream in an ammonia absorber to form an ammonia rich stream and a hydrogen cyanide stream; and recovering hydrogen cyanide from the hydrogen cyanide stream; wherein the cooled hydrogen cyanide stream is in the vapor phase. The crude hydrogen cyanide stream may be formed by an oxygen Andrussow process, an air Andrussow process, an enriched air Andrussow process, or a BMA process. The temperature of the crude hydrogen cyanide stream is at least 1000° C. The temperature of the reduced temperature hydrogen cyanide stream is at least 200° C. and the temperature of the cooled hydrogen cyanide stream is at least 130° C. such as 130° C. to 150° C. The first waste heat boiler recovers heat from the crude hydrogen cyanide stream and may produce high-pressure steam while the second waste heat boiler recovers heat from the reduced temperature hydrogen cyanide stream and may produce low-pressure steam. The cooled hydrogen cyanide stream is in the vapor phase and may comprise less than 5 wt. % liquid, e.g., less than 3 wt. % liquid. A lean ammonium phosphate stream may be fed to the ammonia absorber. Additionally, an acid stream, e.g., a dilute acid stream, may be fed to the ammonia absorber and may comprise phosphoric acid. The ammonia rich stream may comprise greater than 50 wt. % of the ammonia from the crude hydrogen cyanide stream.

In still another embodiment, the present invention is directed to a method for recovering hydrogen cyanide from a crude hydrogen cyanide stream, comprising: passing the crude hydrogen cyanide stream comprising hydrogen cyanide and ammonia through a first waste heat boiler to reduce the temperature of the hydrogen cyanide stream; directly passing the reduced temperature hydrogen cyanide stream through a second waste heat boiler to cool the reduced temperature hydrogen cyanide stream, wherein the cooled hydrogen cyanide stream remains in the gas phase; separating the cooled hydrogen cyanide stream in an ammonia absorber to form an ammonia rich stream and a hydrogen cyanide stream; and recovering hydrogen cyanide from the hydrogen cyanide stream. The first waste heat boiler may produce high-pressure steam having a pressure of at least 690 kPa. The ammonia rich stream may be further purified and the high-pressure steam may at least partially heat a distillation column in the ammonia rich stream purification. The second waste heat boiler may produce low-pressure steam having a pressure of less than 690 kPa. The low-pressure steam may at least partially heat a distillation column in the hydrogen cyanide recovery. In other aspects, the heat recovered from the first waste heat boiler and/or the second waste heat boiler may be used to pre-heat reactants to form the crude hydrogen cyanide stream. The temperature of the crude hydrogen cyanide stream may be at least 1000° C. The temperature of the reduced temperature hydrogen cyanide stream may be at least 200° C., preferably from 200° C. to 300° C. The temperature of the cooled hydrogen cyanide stream may be at least 120° C., preferably from 120° C. to 200° C. The cooled hydrogen cyanide stream may comprise less than 5 wt. % liquid, preferably less than 3 wt. % liquid. The crude hydrogen cyanide stream may be formed by a hydrogen cyanide synthesis process selected from the group consisting of an oxygen Andrussow process, an air Andrussow process, an oxygen-enriched air Andrussow process, and BMA process. The ammonia rich stream may comprise greater than 50 wt. % of the ammonia from the crude hydrogen cyanide stream. In some aspects, no acid is added to the hydrogen in the first waste heat boiler or in the second waste heat boiler. In additional aspects, no liquid is added to the hydrogen cyanide in the first waste heat boiler or in the second waste heat boiler. The cooled hydrogen cyanide stream may be further cooled in one or more additional waste heat boilers prior to separating, provided that the further cooled hydrogen cyanide stream remains in the gas phase.

### BRIEF DESCRIPTION OF THE DRAWING

FIG. 1 is a schematic representation of one HCN production and recovery system.

### DETAILED DESCRIPTION OF THE INVENTION

Reference will now be made in detail to certain claims of the disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

References in the specification to “one embodiment,” “an embodiment,” “an example embodiment,” etc., indicate that the embodiment described may include a particular feature, structure, or characteristic, but every embodiment may not necessarily include all of the particular features, structures, or characteristics. Moreover, such phrases are not necessarily referring to the same embodiment. Further, when a particular feature, structure, or characteristic is described in connection with an embodiment, it is within the knowledge of one of ordinary skill in the art to include such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.1% to 0.5%, 1.1% to 2.2%, 3.3% to 4.4%) within the indicated range.

In this document, the terms “a,” “an,” or “the” are used to include one or more than one unless the context clearly dictates otherwise. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Language used in the present disclosure, such as the transitional phrases “including,” “comprising,” “having,” “containing,” or “involving,” and variations thereof, is intended to be broad and encompass a composition, a group of elements, a process or method steps, or any other expression listed thereafter, as well as equivalents, and additional subject matter not recited. Further, the transitional phrases “comprising,” “including,” or “containing,” are intended to encompass narrow language, such as the transitional phrases “consisting essentially of,” “consisting of,” or “selected from the group of consisting of,” preceding the recitation of the composition, the group of elements, the process or the method steps or any other expression.

In the methods of manufacturing described herein, the steps can be carried out in any order without departing from the principles of the invention, except when a temporal or operational sequence is explicitly recited.

Furthermore, specified steps can be carried out concurrently unless explicit claim language recites that they should be carried out separately. For example, a claimed step of doing X and a claimed step of doing Y can be conducted simultaneously within a single operation, and the resulting process will fall within the literal scope of the claimed process.

### Definitions

The term “about” can allow for a degree of variability in a value or range, for example, within 10%, within 5%, or within 1% of a stated value or of a stated limit of a range. When a range or a list of sequential values is given, unless otherwise specified any value within the range or any value between the given sequential values is also disclosed.

The term “air” as used herein refers to a mixture of gases with a composition about identical to the native composition of gases taken from the atmosphere, generally at ground level. In some examples, air is taken from the ambient surroundings. Air has a composition that includes about 78% nitrogen, 21% oxygen, 1% argon, and 0.04% carbon dioxide, as well as small amounts of other gases.

The term “room temperature” as used herein refers to ambient temperature, which can be, for example, between about 15° C. and about 28° C.

The term “gas” as used herein includes a vapor.

The term “waste heat boiler” as used herein refers to a heat recovery unit used for generating steam by recovering heat from a stream fed to the waste heat boiler. Any suitable heat recovery unit known in the art may be used, including, for example, a steam boiler.

The term “ammonia absorber” as used herein refers to a unit used for removing ammonia from a stream comprising hydrogen cyanide and ammonia.

The term “transfer piping” as used herein refers to materials and equipment, such as pipes, pumps, and other equipment, which transfers reactor chemicals from one piece of equipment to another, such as between a reactor and a first waste heat boiler, between a second waste heat boiler and an ammonia absorber, or between a first heat boiler and a second waste heat boiler.

### DESCRIPTION

The present invention provides a method of increasing process efficiency in the recovery of HCN. The present invention further provides a system (also referred to herein as “apparatus”) that can perform the method.

Conventionally, hydrogen cyanide (or “HCN”) is produced on an industrial scale according to either the Andrussow process or the BMA process. In the Andrussow process, as more fully described in U.S. Pat. No. 1,934,838 (the entire contents of which are incorporated herein by reference in its entirety), methane, ammonia and oxygen raw materials are reacted at temperatures above about 1000° C. in the presence of a catalyst to produce HCN, hydrogen, carbon monoxide, carbon dioxide, nitrogen, residual ammonia, residual methane, and water. Natural gas is typically used as the source of methane while air, oxygen-enriched air, or pure oxygen can be used as the source of oxygen. The catalyst is typically a wire mesh platinum/rhodium alloy or a wire mesh platinum/iridium alloy. Optionally the HCN can be produced via the BMA process wherein the HCN is synthesized from methane and ammonia in the substantial absence of oxygen resulting in the production of HCN, hydrogen, nitrogen, residual ammonia, and residual methane (see e.g., Ullman's Encyclopedia of Industrial Chemistry, Volume A8, Weinheim 1987, pages 161-163 incorporated herein by reference). It should be clear to one of ordinary skill in the art that the herein disclosed and/or claimed inventive process(es), methodology(ies), apparatus(es) and composition(s) are applicable to any crude HCN stream containing at least HCN and ammonia. The herein disclosed and/or claimed inventive process(es), methodology(ies), apparatus(es) and composition(s) are also applicable to refining and purification of HCN from other sources including, but not limited to, HCN byproduct from acrylonitrile synthesis. Such other sources may also include inhibited HCN whereby the herein disclosed and/or claimed inventive process(es), methodology(ies), apparatus(es) and composition(s) may be used to remove the inhibitor. The herein disclosed and/or claimed inventive process(es), methodology(ies), apparatus(es) and composition(s) can be used to produce purified uninhibited HCN suitable for hydrocyanation.

The term “hydrocyanation” as used herein is meant to include hydrocyanation of aliphatic unsaturated compounds comprising at least one carbon-carbon double bond or at least one carbon-carbon triple bond or combinations thereof, and which may further comprise other functional groups including, but not limited to, nitriles, esters, and aromatics. Examples of such aliphatic unsaturated compounds include, but are not limited to, alkenes (e.g., olefins); alkynes; 1,3-butadiene; and pentenenitriles. The purified uninhibited HCN produced by the herein disclosed and/or claimed inventive process(es), methodology(ies), apparatus(es) and composition(s) is suitable for hydrocyanation as stated above, including 1,3-butadiene and pentenenitrile hydrocyanation to produce adiponitrile (ADN). ADN manufacture from 1,3-butadiene involves two synthesis steps. The first step uses HCN to hydrocyanate 1,3-butadiene to pentenenitriles. The second step uses HCN to hydrocyanate the pentenenitriles to adiponitrile (ADN). This ADN manufacturing process is sometimes referred to herein as hydrocyanation of butadiene to ADN. ADN is used in the production of commercially important products including, but not limited to, 6-aminocapronitrile (ACN); hexamethylenediamine (HMD); epsilon-caprolactam; and polyamides such as nylon 6 and nylon 6,6.

The term “uninhibited HCN” as used herein means that the HCN is depleted of stabilizing polymerization inhibitors. As understood by those skilled in the art, such stabilizers are typically added during the cooling and/or recovery of HCN to minimize polymerization and require at least partial removal of the stabilizers prior to utilizing the HCN in hydrocyanation of, for example, 1,3-butadiene and pentenenitrile to produce ADN. HCN polymerization inhibitors include, but are not limited to mineral acids, such as sulfuric acid and phosphoric acid; organic acids such as acetic acid; sulfur dioxide; and combinations thereof.

The formation of HCN in the Andrussow process is often represented by the following generalized reaction:

2CH₄+2NH₃+30₂→2HCN+6H₂O

However, it is understood that the above reaction represents a simplification of a much more complicated kinetic sequence where a portion of the hydrocarbon is first oxidized to produce the thermal energy necessary to support the endothermic synthesis of HCN from the remaining hydrocarbon and ammonia.

The synthesis of HCN is conducted in a reactor (e.g., converter or other vessel suitable for conducting the reaction) that contains the catalyst. Typically, stream(s) containing ammonia, methane and oxygen are preheated, either independently or in combination, and mixed to obtain a reactor feed stream having a desired temperature and a desired pressure at the catalyst to produce HCN. The use of air (i.e., containing 21 mole % oxygen) as the source of oxygen in the production of HCN results in the combustion and HCN synthesis being performed in the presence of a large volume of inert nitrogen. Such a large volume of inert nitrogen necessitates the use of appropriately sized air compressors, reactor, and downstream equipment. Additionally, because of the presence of the inert nitrogen, more methane is required to be combusted than is required to raise the temperature of the reactants to a temperature at which the HCN synthesis can be sustained. It is advantageous to use oxygen-enriched air or oxygen as the oxidant feed to the reactor (i.e., to reduce the concentration of inerts such as nitrogen) in order to increase productivity and the yield of HCN produced by the reaction, reduce the size of HCN synthesis equipment, such as the reactor, reduce the size of at least one component of the gas handling equipment downstream of HCN synthesis, and reduce the energy consumption required to heat the oxidant feed. Operating conditions (e.g., feed composition, pressure, preheat temperature, reaction temperature, residence time, velocity) are chosen to maximize efficiency (yield, selectivity, productivity) while maintaining operational stability.

In practice, the discharge stream from the HCN synthesis reactor (sometimes referred to herein as the crude hydrogen cyanide stream) contains HCN and may also include by-product hydrogen, methane combustion byproducts (such as carbon dioxide, carbon monoxide, and water), nitrogen, residual methane, and residual ammonia.

The crude hydrogen cyanide stream may be derived from an Oxygen Andrussow Process, from an Air Andrussow Process, or from a BMA Process, each of which is briefly described above. Crude hydrogen cyanide stream compositions, both exact numbers and expected ranges, are shown below in Table 1.

TABLE 1
Nominal Compositions of HCN Reactor Discharge

| | Oxygen | | Air Andrussow | | | |
|---|---|---|---|---|---|---|
| Nominal | Andrussow | | Process | | BMA Process | |
| Composition, | Process | | (Ullmann's) | | (Ullmann's) | |
| mole %:* | Exact | Range | Exact | Range | Exact | Range |
| H₂ | 34.5 | 30 to 40 | 13.3 | 7 to 17 | 71.8 | 60 to 80 |
| N₂ | 2.4 | 0.01 to 5 | 49.2 | 40 to 60 | 1.1 | 0.01 to 5 |
| CO | 4.7 | 0.01 to 10 | 3.8 | 0.01 to 7 | — | — |
| Ar | 0.1 | 0.01 to 0.5 | — | — | — | — |
| CH₄ | 0.8 | 0.01 to 2 | 0.3 | 0.01 to 1 | 1.7 | 0.01 to 5 |
| CO₂ | 0.4 | 0.01 to 1 | 0.4 | 0.01 to 1 | — | — |
| NH₃ | 6.6 | 3 to 10 | 2.3 | 1 to 5 | 2.5 | 0.01 to 5 |
| HCN | 16.9 | 10 to 20 | 7.6 | 5 to 15 | 22.9 | 15 to 30 |
| Other nitriles | <0.1 | 0.01 to 1 | ** | ** | ** | ** |
| H₂O | 33.4 | 25 to 45 | 23.1 | 15 to 30 | — | — |
| ***Estimated Dew | 71.8 | 65 to 80 | 63.6 | 50 to 70 | −9.0 | −15 to 0 |
| Point Temperature | | | | | | |
| @ 1 atm, ° C. | | | | | | |

*For ideal gases, mole % is equivalent to volume %. The nominal compositions in Table 1 are intended to be generally representative; actual compositions may vary from those shown.
** Not listed in Ullmann's but expected to be present.
***Not listed in Ullmann's.
Dew point temperature is estimated at 1 atm (101.3 kPa) absolute pressure for the nominal composition listed.

The Andrussow process, when practiced at optimal conditions, has potentially recoverable residual ammonia in the crude hydrogen cyanide stream. Because the rate of HCN polymerization is known by a person of ordinary skill in the art to increase with increasing pH, residual ammonia must be removed to avoid the polymerization of the HCN. HCN polymerization represents not only a process productivity problem, but an operational challenge as well, since polymerized HCN can cause process line and transfer piping blockages resulting in pressure increases and associated process control problems. Polymerization is a greater concern when cooling the HCN from the reactor due to the larger amounts of ammonia. When fouling occurs, the water scrubbed cooler(s) require periodic caustic cleaning. Cleaning may only occur during reactor shut down. However, cooling is needed to prevent decomposition of HCN.

In conventional processes, the crude hydrogen cyanide product stream exits the reactor at high temperature, e.g., about 1200° C., and is rapidly quenched in a waste heat boiler to less than 400° C., less than 300° C. or less than 250° C. Although this quenching may prevent decomposition, it is still too hot and may cause fouling when ammonia is separated in downstream separation processes. The further quenching may be accomplished by a cooler, preferably a water-scrubbed cooler, to cool the crude hydrogen cyanide product stream to less than 130° C., e.g., less than 100° C. or less than 90° C. The cooler may use water or other known coolants, to cool the crude hydrogen cyanide stream while at the same time preventing the decomposition of hydrogen cyanide and ammonia within the stream. Due to the high amounts of ammonia, inhibitors may be used with the coolant to prevent polymerization during cooling. Once the gas has been cooled, ammonia is separated from the crude hydrogen cyanide stream in the first step of the refining process, and HCN polymerization is inhibited by immediately reacting the crude hydrogen cyanide stream with an excess of acid (e.g., H₂SO₄ or H₃PO₄) such that the residual free ammonia is captured by the acid as an ammonium salt and the pH of the solution remains acidic. Formic acid and oxalic acid in the ammonia recovery feed stream are captured in aqueous solution in an ammonia recovery system as formates and oxalates.

The requirement of low water, and the high purity required of HCN when it is to be used as a feed stream in a hydrocyanation process, such as the hydrocyanation of 1,3-butadiene (sometimes referred to herein as “butadiene”) and pentenenitrile to produce adiponitrile, necessitate a method of producing and processing uninhibited HCN. Such inhibitors would require removal prior to utilizing the HCN in, for example, hydrocyanation, such as in the manufacture of adiponitrile by hydrocyanation of 1,3-butadiene and hydrocyanation of pentenenitriles, and other conversion processes known to those skilled in the art.

The recovery of ammonia and HCN requires a large amount of energy to drive the separation. It has been surprisingly and unexpectedly discovered that using multiple heat exchangers in series can achieve the necessary cooling, avoid polymerization or the introduction of inhibitors during cooling, and recover energy for the ammonia and HCN recovery. In some aspects, two heat exchangers are used in series. Advantageously, the cooler is replaced with a second waste heat boiler and polymerization of HCN is decreased between the first waste heat boiler and the ammonia absorber, allowing for increased process efficiency and maximized yield of HCN. Additionally, because no coolant is used, impurities that may be present in the coolant are not introduced into the crude hydrogen cyanide stream and equipment fouling is reduced. A further advantage of the present invention is that the second waste heat boiler forms low-pressure steam, which may be used within the process, resulting in significant energy and cost savings. In some aspects, depending on the pressure of the low-pressure steam and depending on the pressure desired for use of the low-pressure steam within the process, an injector may be used to inject higher pressure steam to increase the pressure of the low-pressure steam. For example, if the low-pressure steam has a pressure of 250 kPa, an steam having a pressure of 1300 kPa may be injected into the low-pressure steam to increase the pressure of the low-pressure steam to 500 kPa.

These advantages are still present even when compared to a process where the water-scrubbed cooler is omitted and only one waste heat boiler is used. Even though such a process may avoid HCN polymerization and form high-pressure steam by not cooling the crude hydrogen cyanide stream to the temperatures disclosed herein, since the ammonia absorber does not require heat, the heat from the crude hydrogen cyanide stream would be wasted, resulting in cost and energy inefficiencies. Because of the reduced fouling, the second waste heat boiler does not require a caustic cleaning, which is a further advantage over using a water-scrubbed cooler.

As described herein, the crude hydrogen cyanide stream is passed through a first waste heat boiler and high-pressure steam is formed. The first waste heat boiler reduces the temperature of the crude hydrogen cyanide stream based on the pressure of high-pressure steam desired. The second waste heat boiler may have inlet temperatures from 200° C. to 300° C., e.g., from 200° C. to 250° C. or from 200° C. to 240° C., and exit temperatures from 120° C. to 200° C., e.g., from 130° C. to 170° C., from 130° C. to 150° C. or 130° C. to 140° C. Without being bound by theory, it is believed that by omitting the introduction of a coolant, i.e. water, into the crude hydrogen cyanide stream, the crude hydrogen cyanide stream remains in the gas phase and is not condensed. The crude hydrogen cyanide stream in the gas phase contains less than 5 wt. % liquid, e.g., less than 3 wt. %, less than 1 wt. %, or less than 0.1 wt. % liquid is present in the crude hydrogen cyanide stream. Additionally, the second waste heat boiler allows for easier control of the amount of cooling as compared to a water-scrubbed cooler. Hence, such crude hydrogen cyanide stream is cooled to a temperature from 120° C. to 200° C. and is in the gas phase. When less condensation is present, the HCN is less prone to polymerization, thus reducing the loss of HCN during cooling.

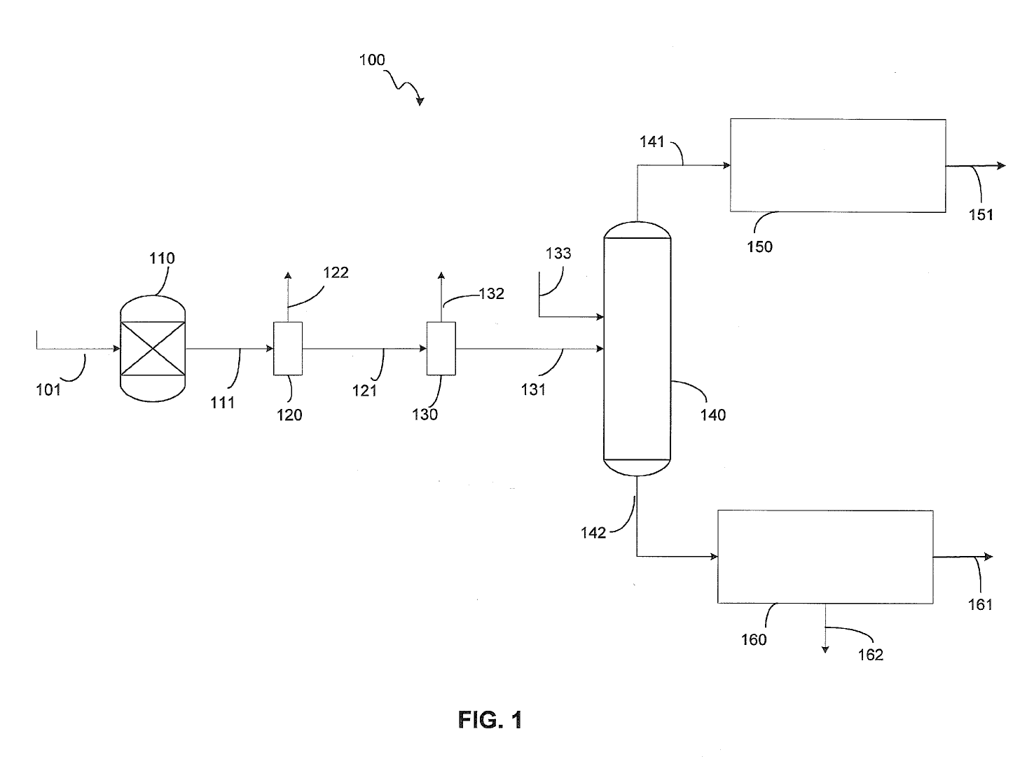

FIG. 1 shows a schematic hydrogen cyanide production and recovery system 100. A reactant feed in line 101 is fed to reactor 110 to form crude hydrogen cyanide stream which exits the reactor 110 in line 111. The crude hydrogen cyanide stream may comprise hydrogen cyanide and ammonia. The crude hydrogen cyanide stream may further comprise hydrogen, nitrogen, carbon monoxide, carbon dioxide, argon, methane, water, and other nitriles, depending on the reactants in the reactant feed and depending on reaction conditions.

Crude hydrogen cyanide stream 111 may be formed by a hydrogen cyanide synthesis process, e.g., an oxygen Andrussow process, an air Andrussow process, an oxygen-enriched air Andrussow process, a combination thereof or a BMA process. Crude hydrogen cyanide stream 111 exits the reactor at a temperature of at least 1000° C. to 1250° C., in some embodiments at a temperature of about 1200° C., and is fed to a first waste heat boiler 120. First waste heat boiler 120 removes heat from crude hydrogen cyanide stream 111 to reduce the temperature of hydrogen cyanide stream 121, and generate high-pressure steam. In one embodiment, quenching of crude hydrogen cyanide stream 111 occurs in the waste heat boiler 120 located below the catalyst bed in reactor 110. Reduced temperature hydrogen cyanide stream has a temperature of at least 200° C., e.g., preferably from 200° C. to 300° C. which is the inlet temperature of the second waste heat boiler 130. Depending on the transfer piping between the first and second waste heat boiler, the reduced temperature hydrogen cyanide may have a temperature of at least 250° C. or at least 300° C. Thus, no further cooling is needed between the first and second waste heat boilers. The heat that is removed from crude hydrogen cyanide stream 111 in line 122 is used to form high-pressure steam, e.g., steam with a pressure of at least 100 psig (at least 690 kPa), at least 125 psig (at least 8501 kPa), at least 150 psig (at least 1000 kPa), or at least 175 psig (at least 1200 kPa). This high-pressure steam is produced by the transfer of heat from the crude hydrogen cyanide stream to water in first waste heat boiler 120.

Reduced temperature hydrogen cyanide stream 121 is then fed, preferably directly, to second waste heat boiler 130, to remove heat from reduced temperature hydrogen cyanide stream 121 to cool the hydrogen cyanide stream 131. Cooled hydrogen cyanide stream 131 has a temperature of at least 130° C., e.g., at least 150° C., or at least 170° C. The heat that is removed from reduced temperature hydrogen cyanide stream 121 in line 132 is used to form low-pressure steam, e.g., steam with a pressure of less than 100 psig (less than 690 kPa), less than 60 psig (less than 420 kPa), or less than 25 psig (less than 175 kPa). The low-pressure steam is formed by the transfer of heat from the reduced temperature hydrogen cyanide stream to water in second waste heat boiler 130.

The high-pressure steam and low-pressure steam may be used to pre-heat the reactor feed, to heat transfer piping, or to heat other sections of system 100. In one embodiment, the high-pressure steam may be used to provide heat to an ammonia stripper described herein and the low-pressure steam may be used to provide heat to an HCN stripper described herein. Together the first and second waste heat boilers effectively recover the heat of reaction (i.e., combustion) produced during the conversion of the reactant feed into HCN. The ammonia stripper and HCN stripper require significant amounts of energy and the heat economy of the process may be improved by obtaining two streams for heat integration with different parts of the recovery process.

It is understood that although a first waste heat boiler and a second waste heat boiler are shown, additional waste heat boilers may be included to maximize waste heat recovery. It is further understood that crude hydrogen cyanide stream 111 may be fed directly to first waste heat boiler 120 with no intermittent separation or treatment steps. Reduced temperature hydrogen cyanide stream 131 may be fed directly from first waste heat boiler 120 to second waste heat boiler 130 to form cooled hydrogen cyanide stream 131. After crude hydrogen cyanide stream 111 has been cooled by the two or more waste heat boilers, with no intermittent additional treatment, cooling, or separation steps, the cooled hydrogen cyanide stream is processed to remove ammonia. During the above described cooling steps, no inhibitors or stabilizers are added to the crude hydrogen cyanide stream. Thus, no liquid is introduced into the crude hydrogen cyanide stream and the crude hydrogen cyanide stream remains in the gas phase.

The heat recovered by the first waste heat boiler and the second waste heat boiler can be used to generate pressurized steam as described above and/or to preheat the reactor feed in line 101. In one embodiment, each of the first and/or second waste heat boilers is a natural circulation waste heat boiler used to generate steam, and a 2-phase water/steam mixture is removed at multiple points along a circumference near an uppermost portion of the first and/or second waste heat boilers through steam riser tubes (not shown) to a steam drum (not shown). In some embodiments, the tubes may have a ferrule to prevent damage at the inlet of the waste heat boiler. Steam is disengaged in the steam drum and the remaining condensate is returned through downcomer tubes (not shown) to multiple points along a circumference near a lowermost portion of the waste heat boiler. The number of removal/return points and the diameters and orientations of the steam riser tubes and downcomer tubes are sufficient to provide improved flow uniformity at the uppermost portion of the waste heat boiler, sufficient surface wetting to reduce localized over-heating of the upper tube sheet, and acceptable velocity and vibration in steam riser tubes and downcomer tubes. When the recovered heat is used to preheat reactor feed 101, the amount of reactant gas (not shown) consumed during synthesis in reactor 110 can be reduced, and the yield of HCN, based upon each of the reactant gas feed, is increased significantly.

Returning to FIG. 1, cooled hydrogen cyanide stream 131 is then fed to ammonia absorber 140, where ammonia and hydrogen cyanide are separated to form an ammonia rich stream in line 142 and a hydrogen cyanide rich stream in line 141. A phosphate stream in line 133 is also fed to ammonia absorber 140. The phosphate stream may comprise phosphoric acid. In some embodiments, the phosphate stream is a lean ammonium phosphate stream, having an ammonia to phosphate molar ratio of about 1.3. In other embodiments, alternative phosphates are used, as discussed herein.

The compositions of ammonia rich stream in line 142 and hydrogen cyanide rich stream in line 141 are provided below in Table 2.

TABLE 2
Nominal Compositions of HCN Crude Product Stream and Ammonia
Rich Stream Using Air Andrussow Process

| | Stream 141 | Stream 142 |
|---|---|---|
| Nominal Composition, | | |
| mole %: | | |
| H₂ | 15 to 20 | <.01 |
| N₂ | 43 to 53 | <.01 |
| CO | 0.01 to 8 | <.01 |
| Ar | 0.01 to 2 | <.01 |
| CH₄ | <1 | <.01 |
| CO₂ | <1 | <.01 |
| NH₃ | <1 | 10 to 20 |
| HCN | 5 to 15 | 0.22 |
| Other nitriles | <.01 | <.01 |
| H₂O | 13 to 23 | 80 to 90 |

Ammonia absorber 140 may utilize packing and/or trays. In one embodiment, the absorption stages in ammonia absorber 140 are valve trays. Valve trays are well known in the art and tray designs are selected to achieve good circulation, prevent stagnant areas, and prevent polymerization and corrosion. In order to avoid polymerization, equipment is designed to minimize stagnant areas generally wherever HCN is present, such as in ammonia absorber 140 as well as in other areas discussed below. Ammonia absorber 140 may also incorporate an entrainment separator above the top tray to minimize carryover. Entrainment separators typically include use of techniques such as reduced velocity, centrifugal separation, demisters, screens, or packing, or combinations thereof.

In another embodiment, ammonia absorber 140 is provided with packing in an upper portion of ammonia absorber 140 and a plurality of valve trays are provided in a lower portion of ammonia absorber 140. The packing acts to reduce and/or prevent ammonia and phosphate from escaping ammonia absorber 140 via hydrogen cyanide rich stream 141. The packing provides additional surface area for ammonia absorption while reducing entrainment in the hydrogen cyanide rich stream 141, resulting in an overall increased ammonia absorption capability. The packing employed in the upper portion of the ammonia absorber 140 can be any low-pressure drop, structured packing capable of performing the above disclosed function. Such packing is well known in the art. An example of a currently available packing which can be employed in the present invention is 250Y FLEXIPAC® packing marketed by Koch-Glitsch of Wichita, Kans. The plurality of fixed valve trays in the lower portion of ammonia absorber 140, construction of which is known in the art, are designed to handle pressure excursions related to start-up and operation of the HCN synthesis system 100.

In a further embodiment, the temperature of the ammonia absorber 140 is maintained, at least in part, by withdrawing a portion of liquid from a lower portion of ammonia absorber 140 and circulating it through a cooler and back into ammonia absorber 140 at a point above the withdrawal point.

In some embodiments, the phosphate stream may comprise an aqueous solution of mono-ammonium hydrogen phosphate (NH₄H₂PO₄) and di-ammonium hydrogen phosphate ((NH₄)₂HPO₄). The phosphate stream may range in temperature from 0° C. to 150° C., e.g., from 0° C. to 110° C. or from 0° C. to 90° C.

In some embodiments, ammonia rich stream 142 comprises a substantial amount of the ammonia from the reactor effluent, e.g., greater than 50 wt. %, greater than 70 wt. %, or greater than 90 wt. %. Ammonia rich stream 142 may be further separated, purified and/or processed, as generally depicted by box 160, to recover the ammonia for recycle to the reactor feed or for other uses in line 161 and to remove impurities and/or particulate matter from the ammonia in line 162. The separation, purification and/or processing of the ammonia rich stream may be conducted with any suitable equipment, as will be apparent to those skilled in the art. In some aspects, box 160 comprises an HCN/phosphate stripper (not shown) which removes residual HCN from the ammonia rich stream. The ammonia rich stream may then be fed to an ammonia stripper (not shown) where ammonia and a portion of the water present in the ammonia rich stream are separated by distillation. Heat for the distillation may be provided at least partially from high-pressure steam in line 122. Due to the high energy demands of the distillation, recovering heat of the reaction is advantageous, especially when energy cost rise. The ammonia stream recovered from the distillation may be further treated to recover purified ammonia.

Returning to hydrogen cyanide rich stream 141, in preferred embodiments, hydrogen cyanide rich stream 141 comprises less than 1000 ppm ammonia, e.g., less than 700 ppm, less than 500 ppm, or less than 300 ppm. The hydrogen cyanide rich stream 141 exiting the ammonia absorber may be further separated, purified and/or processed as depicted by box 150, to recover hydrogen cyanide in line 151.

The separation, purification and/or processing of the HCN rich stream 141 may also be carried out with any suitable equipment, as will be apparent to those skilled in the art. In some aspects, box 150 comprises an HCN scrubber (not shown) to remove free ammonia present in HCN rich stream 141, an HCN absorber (not shown) to remove impurities, including mid-boiling impurities such as nitriles (i.e. acetonitrile, propionitrile, acrylonitrile), and an HCN stripper (not shown). The HCN is treated with dilute acid, e.g., dilute phosphoric acid in the HCN scrubber. Due to the high energy demands of the distillation, recovering heat of the reaction is advantageous, especially when energy cost rise. The HCN stripper may be used to remove acidified water from HCN by distillation. The HCN stream recovered from the distillation may be further treated to recover purified ammonia.

In order to demonstrate the present process, the following examples are given. It is to be understood that the examples are for illustrative purposes only and not to be construed as limiting the scope of the invention.

### EXAMPLE 1

A crude hydrogen cyanide stream is prepared by reacting a ternary gas mixture over a catalyst in a reactor, the ternary gas mixture comprising an ammonia-containing stream, a methane-containing stream and an oxygen-containing stream. The crude hydrogen cyanide stream exits the reactor at a temperature of 1200° C. and is fed to a first waste heat boiler. The crude hydrogen cyanide stream exits the first waste heat boiler at a temperature from 200° C. to 300° C. and is then fed to a second waste heat boiler. The heat removed from the crude hydrogen cyanide stream in the first waste heat boiler forms high-pressure steam having a pressure of at least 100 psig (at least 690 kPa). The crude hydrogen cyanide product is cooled to a temperature from 120° C. to 200° C. in the second waste heat boiler. The heat removed from the crude hydrogen cyanide stream in the second waste heat boiler forms low-pressure steam having a pressure of less than 100 psig (less than 690 kPa). The hydrogen cyanide stream removed from the second waste-heat boiler is in the gas phase and comprises less than 5 wt. % liquid. Thus, the HCN is less prone to polymerization than when the hydrogen cyanide stream comprises 5 wt. % or more liquid.

The high-pressure steam is used to at least partially heat a distillation column of the ammonia stripper in the ammonia recovery section of the process. Additional steam, either from the high-pressure steam of from another steam source is injected into the low-pressure steam via an injector to increase the pressure of the low-pressure steam to 500 kPa. The low-pressure stream is used to at least partially heat a distillation column of the HCN stripper in the HCN recovery section of the process.

The second waste heat boiler has very low fouling or plugging and is kept on-line for at least two years before any caustic cleaning is needed.

### COMPARATIVE EXAMPLE A

A crude hydrogen cyanide stream is prepared as in Example 1. The crude hydrogen cyanide stream exits the reactor at a temperature of 1200° C. and is fed to a waste heat boiler and cooled to a temperature from 200° C. to 300° C. The crude hydrogen cyanide stream is then fed to a water-scrubbed cooler and cooled to a temperature of less than 130° C. No low-pressure steam is able to be recovered from the water-scrubbed cooler and energy is lost.

As the crude hydrogen cyanide stream passes through the water-scrubbed cooler, there is some HCN polymerization. The water in the water-scrubbed cooler has mineral impurities which causes plugging and fouling of the water-scrubbed cooler. After 4 to 6 months, the plugging and fouling requires that the cooler is shut down and cleaned.

From the above descriptions, it is clear that the presently disclosed and/or claimed inventive process(es), methodology(ies), apparatus(es) and composition(s) are well-adapted to carry out the objects and to attain the advantages mentioned herein as well as those inherent in the presently disclosed and/or claimed inventive process(es), methodology(ies), apparatus(es) and composition(s). While the presented embodiments have been described for purposes of this disclosure, it will be understood that numerous changes may be made which will readily suggest themselves to those skilled in the art and which are accomplished within the spirit of the presently disclosed and/or claimed inventive process(es), methodology(ies), apparatus(es) and composition(s).

1. A method for recovering hydrogen cyanide from a crude hydrogen cyanide stream, comprising:
passing the crude hydrogen cyanide stream comprising hydrogen cyanide and ammonia through a first waste heat boiler to reduce the temperature of the hydrogen cyanide stream;
directly passing the reduced temperature hydrogen cyanide stream through a second waste heat boiler to cool the reduced temperature hydrogen cyanide stream, wherein the cooled hydrogen cyanide stream remains in the gas phase;
separating the cooled hydrogen cyanide stream in an ammonia absorber to form an ammonia rich stream and a hydrogen cyanide stream; and
recovering hydrogen cyanide from the hydrogen cyanide stream.

2. The method of claim 1, wherein the first waste heat boiler produces high-pressure steam having a pressure of at least 690 kPa.

3. The process of claim 2, wherein the ammonia rich stream is further purified and wherein the high-pressure steam at least partially heats a distillation column in the ammonia rich stream purification.

4. The method of claim 1, wherein the second waste heat boiler produces low-pressure steam having a pressure of less than 690 kPa.

5. The method of claim 4, wherein the low-pressure steam at least partially heats a distillation column in the hydrogen cyanide recovery.

6. The method of claim 1, wherein heat recovered from the first waste heat boiler and/or the second waste heat boiler is used to pre-heat reactants to form the crude hydrogen cyanide stream.

7. The method of claim 1, wherein the temperature of the crude hydrogen cyanide stream is at least 1000° C.

8. The method of claim 1, wherein the temperature of the reduced temperature hydrogen cyanide stream is at least 200° C., preferably from 200° C. to 300° C.

9. The method of claim 1, wherein the temperature of the cooled hydrogen cyanide stream is at least 120° C., preferably from 120° C. to 200° C.

10. The method of claim 1, wherein the cooled hydrogen cyanide stream comprises less than 5 wt. % liquid, preferably less than 3 wt. % liquid.

11. The method of claim 1, wherein the crude hydrogen cyanide stream is formed by a hydrogen cyanide synthesis process selected from the group consisting of an oxygen Andrussow process, an air Andrussow process, an oxygen-enriched air Andrussow process, and BMA process.

12. The method of claim 1, wherein the ammonia rich stream comprises greater than 50 wt. % of the ammonia from the crude hydrogen cyanide stream.

13. The method of claim 1, wherein no acid is added to the hydrogen in the first waste heat boiler or in the second waste heat boiler.

14. The method of claim 1, wherein no liquid is added to the hydrogen cyanide in the first waste heat boiler or in the second waste heat boiler.

15. The method of claim 1, wherein the cooled hydrogen cyanide stream is further cooled in one or more additional waste heat boilers prior to separating, provided that the further cooled hydrogen cyanide stream remains in the gas phase.
